SEQUENCE LISTING (4 sequences)

SEQ ID NO: 1 - protein, 409 aa, Cynops pyrrhogaster
MRDYIRETQGIALEQFNMQNSHSGVNQLGGVFVNGRPLPDSTRQKIVELAHSGARPCDISRILQVSNGCVSKILGRYYETGSIRPRAIGGSKPRVATPEVVSKIAQYKRECPSIFAWEIRDRLLSEGVCTNDNIPSVSSINRVLRNLASEKQQMGADGMYDKLRMLNGQTGTWGTRPGWYPGTSVPGQPTPDGCQQQEGGGENTNSISSNGEDSDEAQMRLQLKRKLQRNRTSFTQEQIEALEKEFERTHYPDVFARERLAAKIDLPEARIQVWFSNRRAKWRREEKLRNQRRQASNTPSHIPISSSFSTSVYQPIPQPTTPVSFTSGSMLGRTDTSLTNTYGGLPPMPSFTMGNNLPMQVSFPLECQSQYKFPAVNLTCLNTGQDYSKNRANIANDFVENSWMFSSIL

SEQ ID NO: 2 - protein, 1526 aa, Cricetulus longicaudatus
MELSPLQPVNENMQMNKKKNEDAKKRLSIERIYQKKTQLEHILLRPDTYIGSVELVTQQMWVYDEDVGINYREVTFVPGLYKIFDEILVNAADNKQRDPKMSCIRVTIDPENNLISIWNNGKGIPVVEHKVEKMYVPALIFGQLLTSSNYDDDEKKVTGGRNGYGAKLCNIFSTRFTVETASKEYKKMFKQTWMDNMGRAGDMELKPFNGEDYTCITFQPDLSKFKMQSLDKDIVALMVRRAYDIAGSTKDVKVFLNGNKLPVKGFRSYVDMYLKDKLDETGNALKVVHEQVNPRWEVCLTMSEKGFQQISFVNSIATSKGGRHVDYVADQIVSKLVDVVKKKNKGGVAVKAHQVKNHMWIFVNALIENPSFDSQTKENMTLQAKSFGSTCQLSEKFIKAAIGCGIVESILNWVKFKAQIQLNKKCSAVKHNRIKGIPKLDDANDAGSRNSTECTLILTEGDSAKTLAVSGLGVVGRDKYGVFPLRGKILNVREASHKQIMENAEINNIIKIVGLQYKKNYEDEDSLKTLRYGKIMIMTDQDQDGSHIKGLLINFIHHNWPSLLRHRFLEEFITPIVKVSKNKQELAFYSLPEFEEWKSSTPNHKKWKVKYYKGLGTSTSKEAKEYFADMKRHRIQFKYSGPEDDAAISLAFSKKQVDDRKEWLTHFMEDRRQRKLLGLPEDYLYGQTTTYLTYNDFINKELILFSNSDNERSIPSMVDGLKPGQRKVLFTCFKRNDKREVKVAQLAGSVGEMSSYHHGEMSLMMTIINLAQNFVGSNNLNLLQPIGQFGTRLHGGKDSASPRYIFTMLSPLTRLLFPPKDDHTLKFLYDDNQRVEPEWYIPIIPMVLINGAEGIGTGWSCKTPNFDIREVVNNIRRLLDGEEPLPMLPSYKNFKGTIEELASNQYVINGEVAILNSTTIEISELPIRTWTQTYKEQVLEPMLNGTEKTPPLITDYREYHTDTTVKFVIKMTEEKLAEAERVGLHKVFKLQTSLTCNSMVLFDHVGCLKKYDTVLDILKDFFELRLKYYGLRKEWLLGMLGAESAKLNNQARFILEKIDGKIIIENKPKKELIKVLIQRGYDSDPVKAWKEAQQKVPDEEENEESDNENSDSVAESGPTFNYLLDMPLWYLTKEKKDELCKQRNEKEQELNTLKNKSPSDLWKEDLAVFIEELEVVEAKEKQDEQVGLPGKGGKAKGKKAQMSEVLPSPHGKRVIPQVTMEMKAEAEKKIRKKIKSENVEGTPTENGLELGSLKQRIEKKQKKEPGAMTKKQTTLAFKPIKKGKKRNPWSDSESDMSSNESNVDVPPREKDPRRAATKAKFTMDLDSDEDFSGSDGKDEDEDFFPLDTTPPKTKIPQKNTKKALKPQKSAMSGDPESDEKDSVPASPGPPAADLPADTEQLKPSSKQTVAVKKTATKSQSSTSTAGTKKRAVPKGSKSDSALNAHGPEKPVPAKAKNSRKRKQSSSDDSDSDFEKVVSKVAASKKSKGENQDFRVDLDETMVPRAKSGRAKKPIKYLEESDDDDLF

SEQ ID NO: 3 - protein, 426 aa, Human herpesvirus 6
LQSVFAFLHEKIFGVYKQVLVQLCEYIGPDLWPFGNERSVSFIGYPNLWLLSVSDLERRVPDTTYICREILSFCGLAPILGPRGRHAIPVIRELSVEMPGSETSLQRFRFNSQYVSSESLCFQTGPEDTHLFFSDSDMYVVTLPDCLRLLLKSTVPRAFLPCFDENATEIELLLKFMSRLQHRSYALFDAVIFMLDAFVSAFQRACTLMEMRWLLVRDLHVFYLTCDGKDSHVVMPLLQTAVENCWEKITEIKQRPAFQCMEISRCGFVFYARFFLSSGLSQSKEAHWTVTASKYLSACIRANKTGLCFASITVYFQDMMCVFIANRYNVSYWIEEFDPNDYCLEYHEGLLDCSRYTAVMSEDGQLVRQARGIALTDKINFSYYILVTLRVLRRWVESKFEDVEQTEFIRWENRMLYEHIHLLHLN

SEQ ID NO: 4 - protein, 662 aa, Escherichia coli
MHRASANSLLNSVSGSMMWRNQSSGRRPSKRLSDNEATLSTINSILGAEDMLSKNLLSYLPPNNEEIDMIYPSEQIMTFIEMLHGHKNFFKGQTIHNALRDSAVLKKQIAYGVAQALLNSVSIQQIHDEWKRHVRSFPFHNKKLSFQDYFSVWAHAIKQVILGDISNIINFILQSIDNSHYNRYVDWICTVGIVPFMRTTPTAPNLYNLLQQVSSKLIHDIVRHKQNIVTPILLGLSSVIIPDFHNIKIFRDRNSEQISCFKNKKAIAFFTYSTPYVIRNRLMLTTPLAHLSPELKKHNSLRRHQKMCQLLNTFPIKVLTTAKTDVTNKKIMDMIEKEEKNSDAKKSLIKFLLNLSDSKSKIGIRDSVEGFIQEITPSIIDQNKLMLNRGQFRKRSAIDTGERDVRDLFKKQIIKCMEEQIQTQMDEIETLKTTNQMFERKIKDLHSLLETNNDCDRYNPDLDHDLENLSLSRALNIVQRLPFTSVSIDDTRSVANSFFSQYIPDTQYADKRIDQLWEMEYMRTFRLRKNVNNQGQEESITYSNYSIELLIVPFLRRLLNIYNLESIPEEFLFLSLGEILLAIYESSKIKHYLRLVYVRELNQISEVYNLTQTHPENNEPIFDSNIFSPNPENEILEKIKRIRNLRRIQHLTRPNYPKGDQD

(19) United States
(12) Patent Application Publication
(10) Pub. No.: US 2004/0249574 A1
(43) Pub. Date: Dec. 9, 2004

(54) Markovian domain fingerprinting in statistical segmentation of protein sequences

(76) Inventors: Naftali Tishby, Jerusalem (IL); Yevgeny Seldin, Jerusalem (IL); Gill Bejerano, Givatayim (IL); Hanah Margalit, Jerusalem (IL)

Correspondence Address: Anthony Castorina, G E Ehrlich, Suite 207, 2001 Jefferson Davis Highway, Arlington, VA, 22202, US

(21) Appl. No.: 10/471,758

(22) PCT Filed: Apr. 4, 2002
(86) PCT No.: PCT/IL02/00278

Related U.S. Application Data
(60) Provisional application No. 60/281,627, filed on Mar. 30, 2001.

(51) Int. Cl. G06F 19/00

(52) U.S. Cl. 702/19

(57) ABSTRACT

Apparatus for automatic segmentation of non-aligned data sequences comprising structural domains to identify and construct models of the structural domains. The apparatus comprises a soft clustering unit, a refinement unit and an annealing unit. The soft clustering unit iteratively partitions the data sequences and trains variable memory Markov sources, created using a prediction suffix tree data structure, on the data until convergence is reached. The clustering unit also eliminates sources showing low relationships with the data. The refinement unit is connected to the soft clustering unit and splits and perturbs the sources following convergence, to repeat the iterative partitioning at the soft clustering unit, thereby to refine the model. The annealing unit increases the resolution with which the relationships between data and sources is shown, thereby governing the way in which less competitive sources are rejected, and the apparatus outputs the surviving variable memory Markov sources to provide models for subsequent identification of the structural domains.

### FIELD OF THE INVENTION

The present invention relates to Markovian domain fingerprinting and more particularly but not exclusively to use of the same in statistical segmentation of protein sequences.

### BACKGROUND OF THE INVENTION

Characterization of a protein family by its distinct sequence domains is crucial for functional annotation and correct classification of newly discovered proteins. Conventional Multiple Sequence Alignment (MSA) based methods find difficulties when faced with heterogeneous groups of proteins. However, even many families of proteins that do share a common domain contain instances of several other domains, without any common underlying linear ordering. Ignoring this modularity may lead to poor or even false classification results. An automated method that can analyze a group of proteins into the sequence domains it contains is therefore highly desirable.

Numerous proteins exhibit a modular architecture, consisting of several sequence domains that often carry specific biological functions. The subject is reviewed in Bork, P. (1992) Mobile modules and motifs. Curr. Opin. Struct. Biol., 2, 413 421, and also in Bork, P. and Koonin, E. (1996) Protein sequence motifs. Curr. Opin. Struct. Biol., 6, 366 376, the contents of both of these citations hereby being incorporated by reference.

For proteins whose structure has been solved, it can be shown in many cases that the characterized sequence domains are associated with autonomous structural domains (e.g. the C2H2 zinc finger domain). Characterization of a protein family by its distinct sequence domains (also referred to herein as modules) either directly or through the use of domain motifs, or signatures, is crucial for functional annotation and correct classification of newly discovered proteins. In many cases the underlying genes may have undergone shuffling events that have led to a change in the order of modules in related proteins. In other cases a certain module may appear in many proteins, adjacent to different modules. A global alignment that ignores the modular organization of proteins may fail to associate a protein with other proteins that carry a similar functional module but in a different relative sequence location. Also, ignoring the modularity of proteins may lead to clustering of non-related proteins through false transitive associations. Thus, ideally, clustering of proteins into distinct families may be based on characterization of a common sequence domain or a common signature and not on the entire sequence, thus allowing a single sequence to be clustered into several groups in order to achieve such clustering, an unsupervised method for identification of the domains that compose a protein sequence is essential. Many methods have been proposed for classification of proteins based on their sequence characteristics. Most of them are based on a seed Multiple Sequence Alignment (MSA) of proteins that are known to be related. The MSA can then be used to characterize the family in various ways, and examples are given in the following list:

1. by defining characteristic motifs of the functional sites (as in Hofmann, K., Bucher, P., Falquet, L. and Bairoch, A. (1999) The PROSITE database, its status in 1999. Nucleic Acids Res., 27, 215 219),

2. by providing a fingerprint that may consist of several motifs (Attwood, T., Croning, M., Flower, D., Lewis, A., Mabey, J., Scordis, P., Selley, J. and Wright, W. (2000) PRINTS-S: the database formerly known as PRINTS. Nucleic Acids Res., 28, 225 227.),

3. by describing a multiple alignment of a domain using a Hidden Markov Model (HMM) (Bateman, A., Birney, E., Durbin, R., Eddy, S., Howe, K. and Sonnham-mer, E. (2000) The Pfam protein families database. Nucleic Acids Res., 28, 263 266.), or

4. by a position specific scoring matrix (Henikoff, J. G., Greene, E. A., Pietrokovski, S. and Henikoff, S. (2000) Increased coverage of protein families with the Blocks database servers. Nucleic Acids Res., 28, 228 230.).

All the above techniques, however, rely strongly on the initial selection of the related protein segments for the MSA, and the selection is generally case specific and requires expert input. The techniques also rely heavily on the quality of the MSA itself. The calculation is in general computationally intractable, and when remote sequences are included in a group of related proteins, establishment of a good MSA ceases to be an easy task and delineation of the domain boundaries proves even harder. Establishment of an MSA becomes nearly impossible for heterogeneous groups where the shared motifs are not necessarily abundant, nor in linear ordering. It is therefore highly desirable to complement these methods with efficient automatic generation of sequence signatures which can guide the classification and further analysis of the sequences. This need is especially emphasized in view of current large-scale sequencing projects, generating a vast amount of sequences that require annotation. Unsupervised segmentation of sequences, on the other hand, has become a fundamental problem with many important applications such as analysis of texts, handwriting and speech, neural spike trains and indeed bio-molecular sequences. The most common statistical approach to this problem is currently the HMM. HMMs are predefined parametric models and their success crucially depends on the correct choice of the state model. In the common application of HMMs, the architecture and topology of the model are predetermined and the memory is limited to first order. It is rather difficult to generalize these models to hierarchical structures with unknown a-priori state-topology (for an attempt see Fine, S., Singer, Y. and Tishby, N. (1998) The hierarchical hidden Markov model: analysis and applications. Mach. Learn., 32,41 62.). An interesting alternative to the HMM was proposed in Ron, D., Singer, Y. and Tishby, N. (1996) The power of amnesia: learning probabilistic automata with variable memory length. Mach. Learn., 25, 117 149, the contents of which are hereby incorporated by reference. The citation teaches a sub-class of probabilistic finite automata, the Variable Memory Markov (VMM) sources. While these models can be weaker as generative models, they have several important advantages:

(i) they capture longer correlations and higher order statistics of the sequence;

(ii) they can learn in a provably optimal sense using a construction called Prediction Suffix Tree (PST); (Ron et al., 1996; Buhlmann, P. and Wyner, A. (1999) Variable length Markov chains. Ann. Stat., 27, 480 513;

(iii) they can learn very efficiently by linear time algorithms (Apostolico, A. and Bejerano, G. (2000) Optimal amnesic probabilistic automata or how to learn and classify proteins in linear time and space. J. Comput. Biol., 7,381 393);

(iv) their topology and complexity are determined by the data; and, specifically in our context

(v) their ability to model protein families has been demonstrated (Bejerano, G. and Yona, G. (2001) Variations on probabilistic suffix trees: statistical modeling and prediction of protein families. Bioinformatics, 17,23 43).

### SUMMARY OF THE INVENTION

According to a first aspect of the present invention there is thus provided apparatus for automatic segmentation of non-aligned data sequences comprising structural domains to identify of the structural domains and construct models thereof, the apparatus comprising:

a soft clustering unit for:

iteratively partitioning the data sequences and training a plurality of variable memory Markov sources thereon to reach a state of convergence, and

eliminating ones of the variable memory Markov sources showing low relationships with the data,

a refinement unit associated with the soft clustering unit for splitting and perturbing the sources, following convergence, for further iterative partitioning and eliminating at the soft clustering unit, and

an annealing unit, associated with the soft clustering unit, for successively increasing a resolution with which the relationships between data and sources is shown, thereby to render the eliminating a progressive process,

the apparatus being operable to output remaining variable memory Markov sources to provide models for subsequent identification of the structural domains.

Preferably, the sequences are biological sequences.

Preferably, the sequences are protein sequences.

Preferably, the structural domains are functional protein units.

Preferably, the sources comprise prediction suffix trees.

Preferably, the structural domains are from domain families being any one of a group comprising Pax proteins, type II DNA Topiosomerases, and glutathione S-transferases.

According to a second aspect of the present invention there is provided a method for automatic segmentation of non-aligned data sequences comprising structural domains to identify the structural domains and construct models thereof, the method comprising:

iteratively partitioning the data sequences and training a plurality of variable memory Markov sources thereon to reach a state of convergence, and

eliminating ones of the variable memory Markov sources showing low relationships with the data,

splitting and perturbing the sources, following convergence, for further iterative partitioning and eliminating, and

successively increasing a resolution with which the relationships between data and sources is shown, thereby to render the further eliminating a progressive process,

outputting remaining variable memory Markov sources to provide models for subsequent identification of the structural domains.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified diagram of a domain fingerprinting apparatus in accordance with a first embodiment of the present invention,

FIG. 2 is an example of a PST over the alphabet Σ={a,b,c,d,r},

FIG. 3 is a chart showing a segmentation algorithm according to an embodiment of the present invention,

FIG. 4 is a schematic description of the algorithm of FIG. 3,

FIGS. 5, 6, 7 and 8 are graphs showing results signatures,

FIG. 9 is a simplified diagram illustrating a protein fusion event, and

FIG. 10 is a graph showing comparative results obtained using the prior art.

### DESCRIPTION OF THE PREFERRED EMBODIMENTS

The present embodiments disclose a novel method, and corresponding apparatus, for the problem of protein domain detection. The method takes as input an unaligned group of protein sequences. It segments them and clusters the segments into groups sharing the same underlying statistics. A Variable Memory Markov (VMM) model is built using a Prediction Suffix Tree (PST) data structure for each group of segments. Refinement is achieved by letting the PSTs compete over the segments, and a deterministic annealing framework infers the number of underlying PST models while avoiding many inferior solutions. In examples using the above method, it is shown, by matching a unique signature to each domain, that regions having similar statistics correlate well with protein sequence domains,. The method may be carried out in a fully automated manner, and does not require or attempt an MSA, thereby avoiding the need for expert input.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

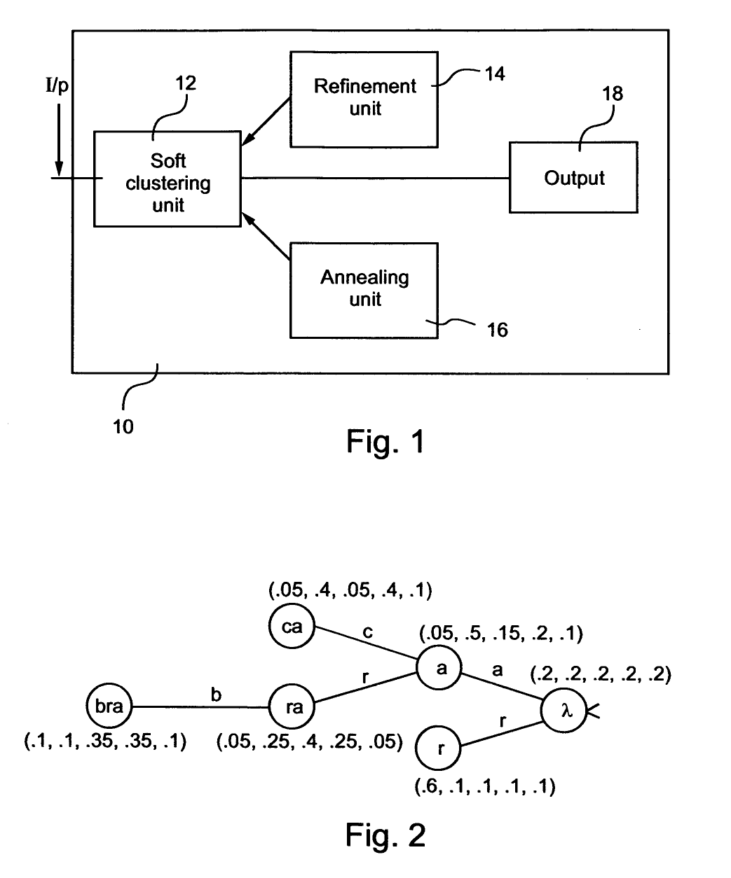

FIG. 1 is a simplified diagram showing apparatus for automatic segmentation of non-aligned data sequences comprising structural domains to identify of the structural domains and construct models thereof, according to a first preferred embodiment of the present invention. Apparatus 10 comprises a soft clustering unit 12, a refinement unit 14 connected thereto, an annealing unit 16 also connected to the soft clustering unit 12, and an output unit 18.

The soft clustering unit 12 carries out two tasks, firstly it iteratively partitions the data sequences and trains a plurality of variable memory Markov sources thereon to reach a state of convergence. Secondly it eliminating sources showing low relationships with the data.

The refinement unit 14 splits and perturbs the sources following convergence, and returns them to the soft clustering unit for further iterative partitioning and eliminating. The perturbed sources provide an opportunity for better convergence.

The annealing unit, successively increases the resolution with which the relationships between data and sources is shown. As this resolution increases progressively, the elimination stage becomes more discriminating and the sources that remain after elimination become better and better models in a process of natural selection.

The output stage 18 outputs the remaining variable memory Markov sources. Provided that the natural selection has been carried to a sufficient extent, the sources that remain are models or electronic signatures for actual structural features within the source material. In the case of proteins the structural features are domains, as will be explained in greater detail below.

As discussed above, the present embodiments apply a powerful extension of the VMM model and the PST algorithm, recently developed for stochastic mixtures of such models (Seldin, Y., Bejerano, G. and Tishby, N. (2001) Unsupervised sequence segmentation by a mixture of switching variable memory Markov sources. Proc. 18^{th} Intl. Conf. Mach. Learn. (ICML). Morgan Kaufmann, San Francisco, Calif., pp. 513 520, the contents of which are hereby incorporated by reference), that are able to learn in a hierarchical way using a Deterministic Annealing (DA) approach (Rose, 1998). Our model can in fact be viewed as an HMM with a VMM attached to each state, but the learning algorithm allows a completely adaptive structure and topology both for each state and for the whole model. The present embodiments are information theoretic in nature. The goal is to enable a short description of the data by a (soft) mixture of VMM models, when the complexity of each model is controlled by the data via the Minimum Description Length (MDL) principle (reviewed in Barron, A., Rissanen, J. and Yu, B. (1998) The minimum description length principle in coding and modeling. IEEE Trans. Inf. Theor., 44, 2743 2760). In effect the embodiments cluster regions of the input sequences into groups sharing coherent statistics. A PST model is grown for each group of segments, the model being as complex as the group is statistically rich. The clustering is then refined by letting the PSTs compete over the segments. Embedding the competitive learning in a DA framework allows the embodiments to try and infer the correct number of underlying sources, and avoid many local minima. The output of the algorithm of the preferred embodiment is a set of PST models, each of which is specialized in recognizing a certain protein region. The models can then be used to detect these regions in any protein.

In Seldin, Y., Bejerano, G. and Tishby, N. (2001) Unsupervised sequence segmentation by a mixture of switching variable memory Markov sources. Proc. 18^{th} Intl. Conf. Mach. Learn. (ICML). Morgan Kaufmann, San Francisco, Calif., pp. 513 520, the contents of which are hereby incorporated by reference, the present inventors tested an embodiment of the algorithm on a mixture of interchanged running texts in five different European languages. The model was able to identify both the correct number of languages and the segmentation of the text sequence between the languages to within a few letters precision. Note that the segmentation there was not based on conserved regions (say, a few sentences, each repeating several times with minor variations), but rather based on the conserved statistics of running text segments in each language. In the present embodiments, statistical conservation is observed in the context of protein sequences.

There are clear advantages to the approach of the present embodiments compared to the common methods used for protein sequence segmentation. The method is automatic, there is no need for an alignment, the motifs themselves need not be few, abundant, or linearly ordered. When a signature is identified in a protein, its statistical significance can be quantitatively evaluated through the likelihood the model assigns to it. Given a group of related sequences the computational scheme of the present embodiments facilitates the segmentation of these sequences into domains through the use of the resulting statistical signatures, at times surpassing the susceptibility of single whole-domain HMMs. By characterizing protein families using these modular signatures it is possible to assign functional annotations to proteins that contain these modules, independent of their order in the protein. The detection of functional domains can then be used to define families and super-family hierarchies.

The examples section below shows an analysis of promising results obtained for three exemplary diverse protein families (Pax, Type II DNA Topoisomerases and GST) and compares these results with those of an alignment-based approach.

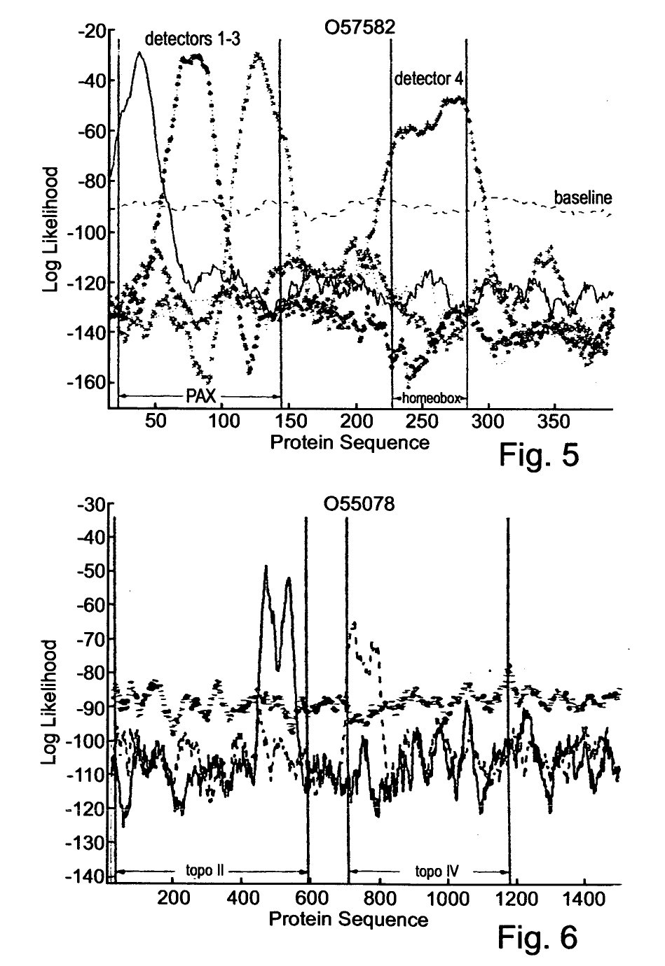

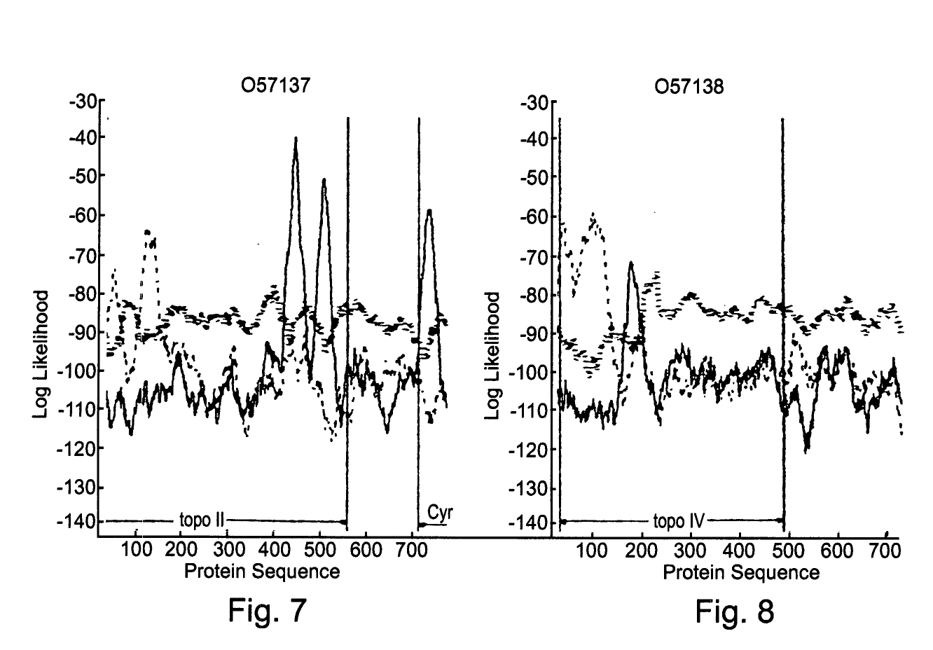

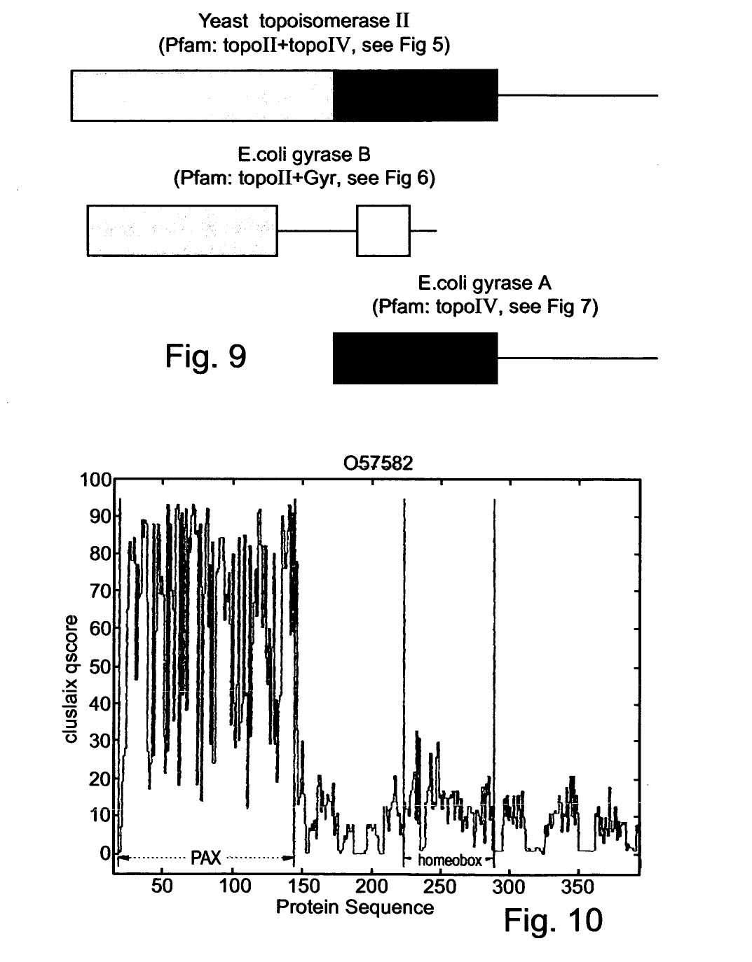

Several works precede the approach we follow in this paper. Learning a single VMM from a group of sequences using a PST model is defined in Ron et al. (1996). Strong theoretical results backing this approach when the underlying source exhibits Markovian-like properties are given in Ron et al. (1996) and Buhlmann and Wyner (1999). Equivalent algorithms of optimal linear time and space complexity for PST learning and prediction are proven in Apostolico and Bejerano (2000). In Bejerano and Yona (2001) partial groups of unaligned sequences from diverse protein families are each used as training sets. Resulting PSTs are shown to distinguish between previously unseen family members and unrelated proteins, matching that of an HMM trained on an MSA of the input sequences in sensitivity, while being much faster. Also noted there (see FIGS. 5 and 6 of Bejerano and Yona, 2001), when plotting the prediction along every residue of a protein sequence, is a correlation between protein domains and regions the family PST recognizes best within family members. That observation motivated the current work. The algorithmic approach of the present embodiments extends PST learning from single source modeling to several competing models, each specializing in regions of coherent statistics.

A statistical model T is considered, which assigns a probability P_{T}(X) to a protein sequence x=x1 . . . xl where the numbered x's are members of the amino acid set or alphabet Σ. The higher the assigned probability P_{T}(x) that the model gives, the greater is our confidence that x belongs to the protein type modeled by T. The amino acids x1 . . . xl are treated as a sequence of dependent random variables and PST modeling is built around the Markovian approximation

$$\begin{matrix}{P}_{T} ( x ) = {\prod }_{J = 1}^{l} {p}_{T} ( {x}_{j} \vert {x}_{1} … {x}_{j - 1} ) \\ \approx {\prod }_{j = 1}^{l} {P}_{T} ( {x}_{j} \vert {suf}_{T} ( {x}_{1} … {x}_{j - 1} ) )\end{matrix}$$

where the equality follows from applying the chain rule and suf_{T} (x₁ . . . xⱼ₋₁) is the longest suffix of x₁ . . . xⱼ₋₁ memorized by T during training.

Reference is now made to FIG. 2 which is an example of a PST over the alphabet={a b c d r}. The string inside each node is a memorized suffix and the adjacent vector is its probability distribution over the next symbol. A PST T is thus a data structure holding a set of short context specific probability vectors of the form P_{T}(x_{j-d} . . . xⱼ₋₁). An example of such a structure is shown in FIG. 2, and short patterns of arbitrary lengths are collected from training sequences regardless of the relative sequence positions of the different instances of each pattern.

As explained in Seldin et al, an MDL based variant of the PST learning is defined, which is non-parametric and is self-regularizing. It allows the PST to grow to a level of complexity proportional to the statistical richness in the sequence it models. As an input it takes a collection of protein sequences (X1 . . . Xn) and a set of weight vectors {w₁ . . . wₙ}, where the jth entry of wᵢ, denoted 0≦wᵢⱼ≦1, measures the degree of relatedness currently assigned between the jth element of xᵢ, xᵢⱼ, and the model it is intended to train. For example, in order to train a PST only on specific regions in the proteins, one may assign wᵢⱼ=1 to those specific regions and wᵢⱼ=0 elsewhere.

The degree of relatedness between a PST model and a sequence segment is defined as the probability the model assigns to the segment, which is to say how well the model predicts the segment. In order to partition the sequence between K=1 . . . m known PST models, one assigns sequence segments from the collection to the models in proportion to the degree of relatedness between a segment and each of the models being used. The result is a series of nm vectors

$${{\{ {w}_{i} \}}^{- k}}_{ i , k}$$

each representing the prediction by one model of one sequence. The vectors therefore constitute a soft partitioning of the sequence collection between the models

$$∀ i , j \text{:} {\sum }_{k} {w}_{i j}^{k} = 1$$

). Each model k may then be retrained using a new set of weights

$${{\{ {w}_{i} \}}^{- k}}_{ i} .$$

Such soft clustering (data repartition followed by model retraining) can be iterated until convergence to a set of PSTs, each one of which models a distinct group of sequence segments. The loop is similar to the iterative loop that is used in soft clustering of points in Rⁿ to k Gaussians.

The quality of the solution that is converged to depends on the number of models and their initial settings. Both issues are solved using iterative refinement. In iterative refinement one begins with a single model T₀ which has been trained over the entire collection of sequences. Tₒ is then split into two identical replicas T₁ and T₂, which are randomly perturbed so that they differ slightly. Repartitioning and training are then repeated and, when the perturbed models converge on a new solution, splitting is repeated. Models that lose their grip on the data during the course of the repartitioning, splitting and training process are eliminated.

Finally, a resolution parameter β>0 is introduced and is gradually increased from a low initial value. The parameter β controls the hardness of the soft partition of sequence segments between the models. As β increases, segments separate more and more into distinct models.

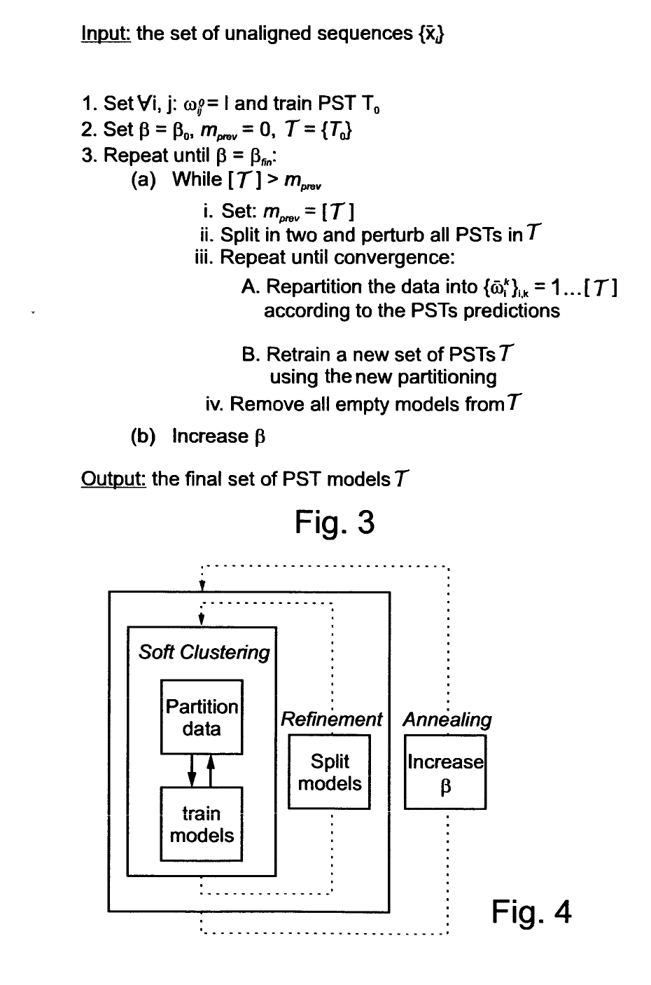

Formally, the process sets

$${w}_{i j}^{k} = \frac{P ( {T}_{k} ) {ⅇ}^{β {S}_{{T}_{K}} ( {x}_{i j} )}}{{\sum }_{α = 1}^{m} P ( {T}_{α} ) {ⅇ}^{β {S}_{{T}_{α}} ( {x}_{i j} )}}$$

where S_{T}_{ₖ} (xᵢⱼ)≦0 is a log-likelihood measure of relatedness between model k and symbol xᵢⱼ and P(Tₖ) corresponds to the relative amount of data assigned to model k in the previous segmentation. As β increases it induces a sharper distinction between the highest scoring S_{T}_{ₖ} (xᵢⱼ) and the other models for each xᵢⱼ. The above described procedure may avoid many local minima and generally yields better solutions than other optimization algorithms. Reference is made to FIG. 3 which is a simplified flow chart illustrating the above described sequence. A schematic representation is shown in FIG. 4.

### EXAMPLES

Several representative cases are analyzed below. A protein fusion event is identified, An HMM superfamily is classified into underlying families that the HMM cannot separate, and all 12 instances of a short domain in a group of 396 sequences are detected.

As discussed above, the input to the segmentation algorithm is a group of unaligned sequences in which to search for regions of one or more types of conserved statistics. In a first example of use of the present embodiments, different training sets were constructed using the Pfam (release 5.4) and Swissprot (release 38, Bairoch and Apweiler, 2000) databases. Various sequence domain families were collected from Pfam. In each Pfam family all members share a domain. An HMM detector is built for that domain based on an MSA of a seed subset of the family domain regions. The HMM is then verified to detect that domain in the remaining family members. Multi-domain proteins therefore belong to as many Pfam families as there are different characterized domains within them.

In order to build realistic, more heterogeneous sets, the present inventors collected from Swissprot the complete sequences of all chosen Pfam families. Each set now contains a certain domain in all its members, and possibly various other domains appearing anywhere within some members. Given such a set of unaligned sequences our algorithm returns as output several PST models (FIG. 3). The number of models returned is determined by the algorithm itself. Each such PST has survived repeated competitions by outperforming the other PSTs on some sequence regions. In practice two types of PSTs emerge for protein sequence data:

1) models that significantly outperform others on relatively short regions (and generally perform poorly on most other regions), which are referred to hereinbelow as detectors, and

2) models that perform averagely over all sequence regions, these are noise (baseline) models and are discarded automatically.

We now turn to analyze the detectors. Thus it is necessary to determine in which sequences they outperform all other models and what is the correlation between detected regions and protein domains? Several interesting results may be achieved from the analysis: First and foremost, the result may give a signature for the common domain or domains. Signatures for other domains that appear only in some proteins, may also appear. Additionally, a signature may exactly cover a domain, revealing its boundaries.

When the Pfam HMM detector cannot model below the superfamily level, it may be possible to outperform it and subdivide into the underlying biological families.

Three of the Pfam-based sets we ran experiments on have been chosen to demonstrate examples covering all the above cases. The three, very different, domain families are the Pax proteins, the type II DNA Topoisomerases and the glutathione S-transferases. Thereafter, the results are compared with those of an MSA-based approach.

Ten independent runs of the (stochastic) segmentation algorithm, implemented in C++, were carried out per family. On a Pentium III 600 MHz Linux machine clear segmentation was usually apparent within an hour or two of run time. It is recalled that each PST detector examined is run over all complete sequences in the set it was grown on in order to determine its nature. In our experiments the signature left by each PST was the same between different runs, and between different proteins sharing the same domain(s). We therefore present only the output of all detector PSTs on representative sequences in a particular run.

3.1 The Pax family

Pax proteins (reviewed in Stuart, E. T., Kioussi, C. and Gruss, P. (1994) Mammalian Pax genes. Annu. Rev. Genet., 28, 219 236. 934) are eukaryotic transcriptional regulators that play critical roles in mammalian development and in oncogenesis. All of them contain a conserved domain of 128 amino acids called the paired or paired box domain (named after the Drosophila paired gene which is a member of the family). Some contain an additional homeobox domain that succeeds the paired domain. Pfam nomenclature names the paired domain PAX. The Pax proteins show a high degree of sequence conservation. One hundred and sixteen family members were used as a training set for the segmentation algorithm, as described above.

Reference is now made to FIG. 5, which shows Paired/PAX homeobox signatures. We superimpose the log likelihood predictions log P T of all four detector PSTs generated by the segmentation algorithm, and an exemplary baseline model (dashed), against the sequence of the PAX6 SS protein. The title holds the protein accession number. At the bottom we denote in Pfam nomenclature the location of the two experimentally verified domains. These are in near perfect match here with the high scoring sequence segments.

In FIG. 5 we superimpose the prediction of all resulting PST detectors over one representative family member. This Pax6 SS protein contains both the paired and homeobox domains. Both have matching signatures. This also serves as an example where the signatures exactly overlap the domains. The graph of family members not having the homeobox domain contains only the paired domain signature. Note that only about half the proteins contain the homeobox domain and yet its signature is very clear.

3.2 DNA Topoisomerase II

Type II DNA topoisomerases are essential and highly conserved in all living organisms (see Roca, J. (1995) The mechanisms of DNA topoisomerases. Trends Biol. Chem., 20, 156 160, for a re-view). They catalyze the interconversion of topological isomers of DNA and are involved in a number of mechanisms, such as supercoiling and relaxation, knotting and unknotting, and catenation and decatenation. In prokaryotes the enzyme is represented by the Escherichia coli gyrase, which is encoded by two genes, gyrase A and gyrase B. The enzyme is a tetramer composed of two gyrA and two gyrB polypeptide chains. In eukaryotes the enzyme acts as a dimer, where in each monomer two distinct domains are observed. The N-terminal domain is similar in sequence to gyrase B and the C-terminal domain is similar in sequence to gyraseA (FIG. 9).

FIG. 9 is a simplified schematic diagram illustrating a protein fusion event and is adapted from Marcotte et al. (1999). The Pfam domain names are added in brackets, together with a reference to our results on a representative homolog. Comparing the PST signatures in FIGS. 6-8 with the schematic drawing of FIG. 9, it is clear that the eukaryotic signature is indeed composed of the two prokaryotic ones, in the correct order, omitting the C-terminus signature of gyrase B (short termed here as Gyr).

In Pfam 5.4 terminology gyrB and the N-terminal domain belong to the DNA topoisoII family, while gyrA and the C-terminal domain belong to the DNA topoisoIV family. Here we term the pairs gyrB/topoII and gyrA/topoIV. For the analysis we used a group of 164 sequences that included both eukaryotic topoisomerase II sequences and bacterial gyrase A and B sequences (gathered from the union of the DNA topoisoII and DNA topoisoIV Pfam 5.4 families). We successfully differentiate them into sub-classes. FIG. 6 describes a representative of the eukaryotic topoisomerase II sequences and shows the signatures for both domains, gyrB/topoII and gyrA/topoIV. FIGS. 7 and 8 demonstrate the results for representatives of the bacterial gyrase B and gyrase A proteins, respectively. The same two signatures are found in all three sequences, at the appropriate locations. Interestingly, in FIG. 7 in addition to the signature of the gyrB/topoII domain another signature appears at the C-terminal region of the sequence. This signature is compatible with a known conserved region at the C-terminus of gyrase B, that is involved in the interaction with the gyrase A molecule. The relationship between the E. coli proteins gyrA and gyrB and the yeast topoisomerase II (FIG. 9) provides a prototypical example of a fusion event of two proteins that form a complex in one organism into one protein that carries a similar function in another organism. Such examples have led to the idea that identification of such similarities may suggest the relationship between the first two proteins, either by physical interaction or by their involvement in a common pathway (Marcotte et al., 1999; Enright et al., 1999). The computational scheme we present can be useful in a search for these relationships.

3.3 The Glutathione S-Transferases

The Glutathione S-Transferases (GST) represent a major group of detoxification enzymes (reviewed in Hayes, J. and Pulford, D. (1995) The glutathione S-transferase super-gene family: regulation of GST and the contribution of the isoen-zymes to cancer chemoprotection and drug resistance. Crit. Rev. Biochem. Mol. Biol., 30, 445 600). There is evidence that the level of expression of GST is a crucial factor in determining the sensitivity of cells to a broad spectrum of toxic chemicals. All eukaryotic species possess multiple cytosolic GST isoenzymes, each of which displays distinct binding properties. A large number of cytosolic GST isoenzymes have been purified from rat and human organs and, on the basis of their sequences they have been clustered into five separate classes designated class alpha, mu, pi, sigma, and theta GST. The hypothesis that these classes represent separate families of GST is supported by the distinct structure of their genes and their chromosomal location. The class terminology is deliberately global, attempting to include as many GSTs as possible. However, it is possible that there are sub-classes that are specific to a given organism or a group of organisms. In those sub-classes the proteins may share more than 90% sequence identity, but these relationships are masked by their inclusion in the more global class. Also, the classification of a GST protein with weak similarity to one of these classes is sometimes a difficult task. In particular, the definition of the sigma and theta classes is imprecise. Indeed, in the PRINTS database only the three classes, alpha, pi, and mu have been defined by distinct sequence signatures, while in Pfam all GSTs are clustered together, for lack of sequence dissimilarity.

In the example, three hundred and ninety six Pfam family members were segmented jointly by our algorithm, and the results were compared to those of PRINTS (as Pfam classifies all as GSTs). Five distinct signatures were found (not shown due to space limitations):

(1) A typical weak signature common to many GST proteins that contain no sub-class annotation.

(2) A sharp peak after the end of the GST domain appearing exactly in all 12 out of 396 (3%) proteins where the Elongation Factor 1 Gamma (EF1G) domain succeeds the GST domain.

(3) A clear signature common to almost all PRINTS annotated alpha and most pi GSTs. The last two signatures require more knowledge of the GST superfamily.

(4) The theta and sigma classes, which are abundant in invertebrates. It is mentioned that, as more and more of these proteins are identified it is expected that additional classes will be defined. The first evidence for a separate sigma class was obtained by sequence alignments of S-crystallins from mollusc lens tissue. Although refractory proteins in the lens probably do not have catalytic activity, they show a degree of sequence similarity to the GSTs that justifies their inclusion in this family and their classification as a separate class of sigma (Buetler, T. and Eaton, D. (1992) Glutathione S-transferases: amino acid sequence comparison, classification and phylogentic relationship. Environ. Carcinogen. Ecotoxicol. Rev., C 10, 181 203). This class, defined in PRINTS as S-crystallin, was almost entirely identified by the fourth distinct signature.

(5) Interestingly, the last distinct signature found is composed of two detector models, one from each of the previous two signatures (alpha pi and S-crystallin). Most of these two dozens proteins come from insects, and of these most are annotated to belong to the theta class. Note that many of the GSTs in insects are known to be only very distantly related to the five mammalian classes. This putative theta sub-class, the previous signatures and the undetected PRINTS mu sub-class are all currently being further investigated.

3.4 Comparative Results

In order to evaluate the above findings we have performed three unsupervised alignment driven experiments using the same sets described above: an MSA was computed for each set using Clustal X (Linux version 1.81, Jean-mougin et al., 1998). We let Clustal X compare the level of conservation between individual sequences and the computed MSA profile in each set. Qualitatively these graphs resemble ours, apart from the fact that they do not offer separation into distinct models. As expected this straightforward approach yields less. We briefly recount some results.

Reference is now made to FIG. 10 which shows Pax MSA profile conservation. We plot the Clustal X conservation score of the PAX6 SS protein against an MSA of all Pax proteins. While the predominant paired/PAX domain is discerned, the homeobox domain (appearing in about half the sequences) is lost in the background noise. The results are to be compared with FIG. 5 where the same training set and plotted sequence are used.

The Pax alignment did not clearly elucidate the homeobox domain existing in about half the sequences. As a result, when plotting the graph comparing the same PAX6 SS protein we used in FIG. 5 against the new MSA in FIG. 10, the homeobox signal is lost in the noise.

For type II topoisomerases the picture is slightly better. The Gyrase B C-terminus unit from FIG. 7 can be discerned from the main unit, but with a much lower peak. However, the clear sum of two signatures we obtained for the eukaryotic sequences (FIG. 6) is lost here. In the last and hardest case the MSA approach tells us nothing. All GST domain graphs look nearly identical precluding any possible subdivision. And the 12 (out of 396) instances of the EF1G domain are completely lost at the alignment phase.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Apparatus for automatic segmentation of non-aligned data sequences comprising structural domains to identify of the structural domains
and construct models thereof, the apparatus comprising:
a soft clustering unit for:
iteratively partitioning said data sequences and training a plurality of variable memory Markov sources thereon to reach a state of convergence, and
eliminating ones of said variable memory Markov sources showing low relationships with the data,
a refinement unit associated with said soft clustering unit for splitting and perturbing said sources, following convergence, for further iterative partitioning and eliminating at said soft clustering unit, and
an annealing unit, associated with said soft clustering unit, for successively increasing a resolution with which said relationships between data and sources is shown, thereby to render said eliminating a progressive process,
said apparatus being operable to output remaining variable memory Markov sources to provide models for subsequent identification of said structural domains.

2. The apparatus of claim 1, wherein said sequences are biological sequences.

3. The apparatus of claim 2, wherein said sequences are protein sequences.

4. The apparatus of claim 3, wherein said structural domains are functional protein units.

5. The apparatus of claim 1, wherein said sources comprise prediction suffix trees.

6. The apparatus of claim 4, wherein said structural domains are from domain families being any one of a group comprising Pax proteins, type II DNA Topiosomerases, and glutathione S-transferases.

7. Method for automatic segmentation of non-aligned data sequences comprising structural domains to identify the structural domains and construct models thereof, the method comprising:
iteratively partitioning said data sequences and training a plurality of variable memory Markov sources thereon to reach a state of convergence, and
eliminating ones of said variable memory Markov sources showing low relationships with the data,
splitting and perturbing said sources, following convergence, for further iterative partitioning and eliminating, and
successively increasing a resolution with which said relationships between data and sources is shown, thereby to render said further eliminating a progressive process,
outputting remaining variable memory Markov sources to provide models for subsequent identification of said structural domains.
